(19) United States
(12) Patent Application Publication
(10) Pub. No.: US 2002/0187756 A1
(43) Pub. Date: Dec. 12, 2002

(54) Multifunctional mobile phone

(76) Inventor: Chien-Kun Chen, Taoyuan City (TW)

Correspondence Address: BACON & THOMAS, PLLC, 625 SLATERS LANE, FOURTH FLOOR, ALEXANDRIA, VA, 22314

(21) Appl. No.: 09/876,124

(22) Filed: Jun. 8, 2001

(51) Int. Cl. H04B 1/38

(52) U.S. Cl. 455/90; 455/550; 455/575

(57) ABSTRACT

A multifunctional mobile phone comprises a razor unit, an illuminator, a pair of contacts, a circuit board, and an operating module having a plurality of keys coupled to circuit board. Razor unit comprises a motor, a vibration mechanism, a razor, a mesh member, and a cap. Circuit board is in a housing for effecting a signal transmitting and a signal receiving comprising a plurality of pairs of rechargeable batteries, a transformer for motor and illuminator, and a booster for increasing an output current of contacts. The operating module is activated to command circuit board for transmitting or receiving signals and operate razor unit, illuminator, and contacts.

### FIELD OF THE INVENTION

The present invention relates to mobile phones and more particularly to a multifunctional mobile phone.

### BACKGROUND OF THE INVENTION

Conventionally, a mobile phone is designed as a portable telephone. But as the times evolved, the functions of a mobile phone has incorporated features of many consumer electronic products to form a multifunctional mobile phone. However, the features of a typical mobile phone are still unsatisfactory for the purpose for which the invention is concerned. Thus improvement exists.

### SUMMARY OF THE INVENTION

It is therefore an object of the present invention to provide a multifunctional mobile phone comprising a razor unit, an illuminator, a pair of contacts, a circuit board, and an operating module having a plurality of keys coupled to circuit board. Razor unit comprises a motor, a vibration mechanism, a razor, a mesh member, and a cap. Circuit board is in a housing for effecting a signal transmitting and a signal receiving comprising a plurality of pairs of rechargeable batteries, a transformer for motor and illuminator, and a booster for increasing an output current of contacts. The operating module is activated to command circuit board for transmitting or receiving signals and operate razor unit, illuminator, and contacts.

The above and other objects, features and advantages of the present invention will become apparent from the following detailed description taken with the accompanying drawings.

### BRIEF DESCRIPTION OF THE DRAWINGS

FIG. 1 is a front perspective view of a first preferred embodiment of multifunctional mobile phone according to the invention where razor unit is on top;

FIG. 2 is a rear perspective view of FIG. 1;

FIG. 3 is a front perspective view of a second preferred embodiment of multifunctional mobile phone according to the invention where razor unit is on bottom;

FIG. 4 is an exploded perspective view of the razor unit of FIG. 1 where a mesh-like razor unit is shown;

FIG. 5 is a view similar to FIG. 4 where a razor unit having a plurality of longitudinal blades is shown;

FIG. 6 is a sectional view of FIG. 1;

FIG. 7 is a top plan view of razor unit and surrounding portion thereof; and

FIG. 8 is an enlarged fragmentary view of a portion of razor unit shown in FIG. 6.

### DETAILED DESCRIPTION OF THE PREFERRED EMBODIMENTS

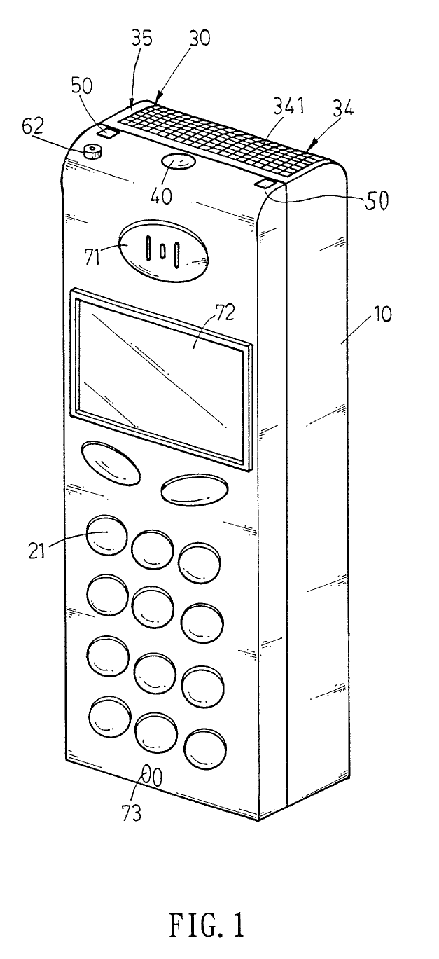

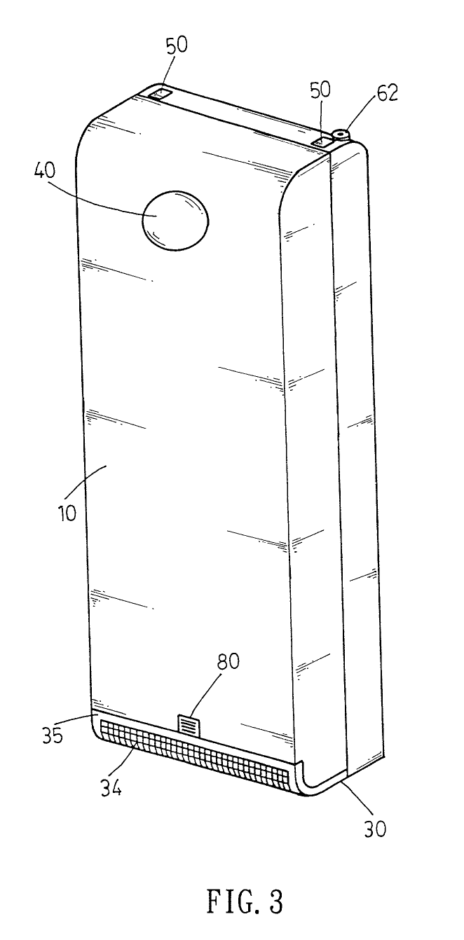

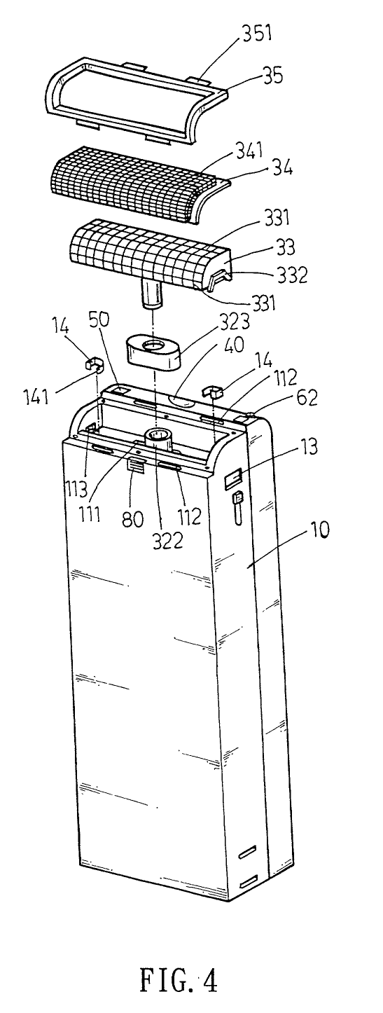

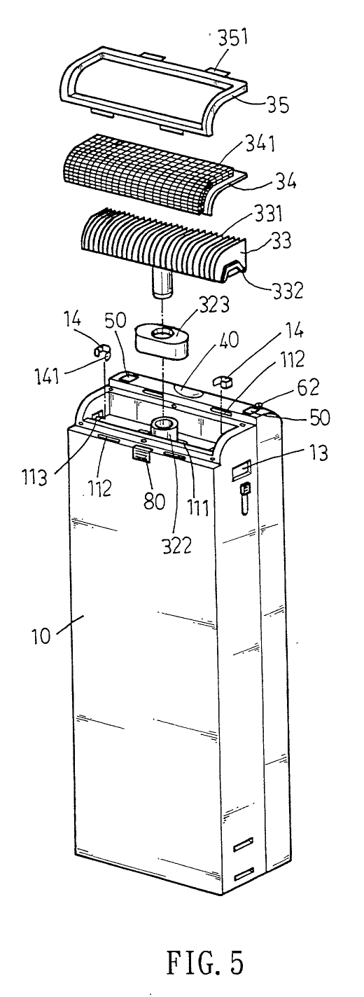

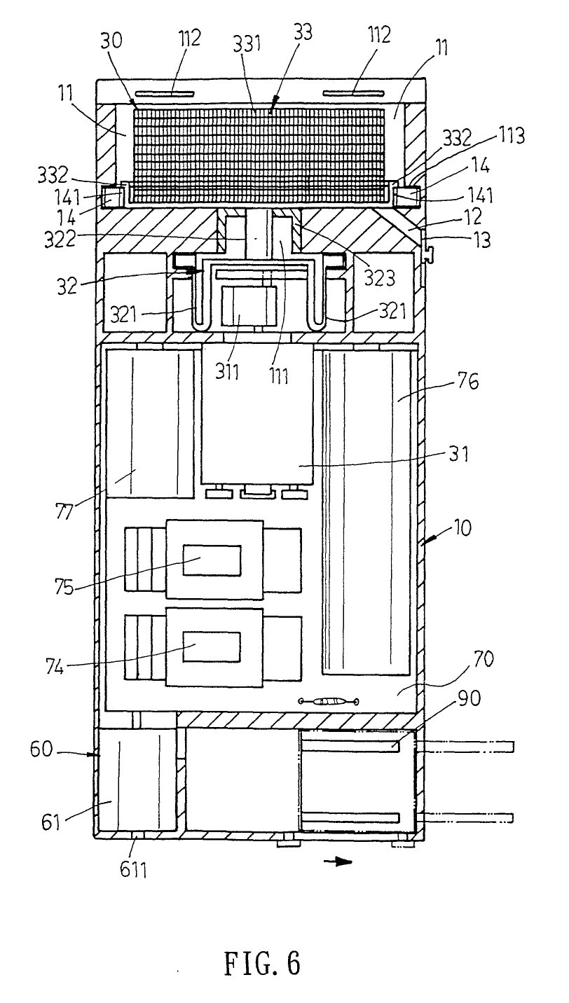

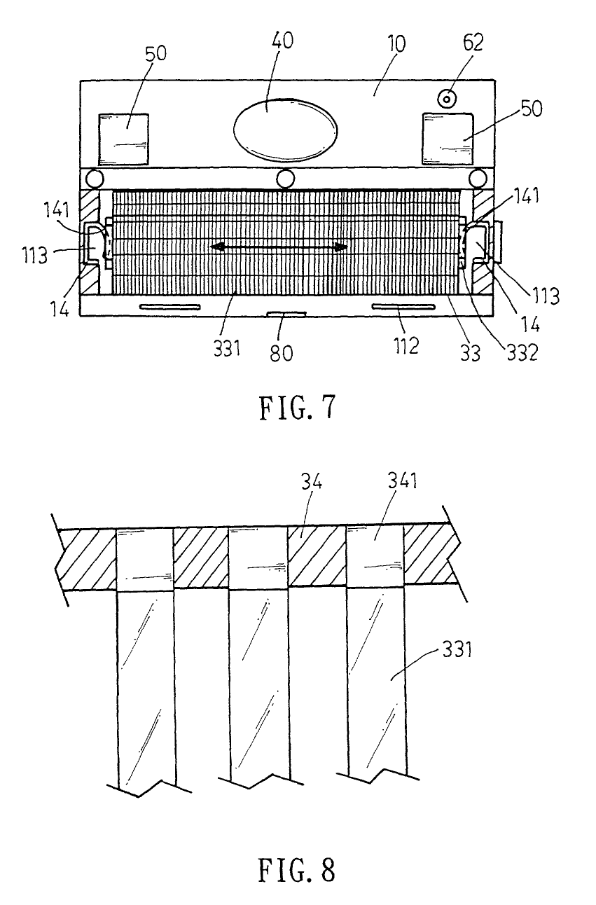

Referring to FIGS. 1 to 8, there is shown a multifunctional mobile phone constructed in accordance with the invention comprising an operating module 20, a razor unit 30, an illuminator 40, a contact 50, and a circuit board 70. Each of above components will now be described. Operating module 20 is provided on the front side of housing 10 having a plurality of keys 21 used for manipulating razor unit 30, illuminator 40, contact 50 and circuit board 70. Operating module is coupled to the circuit board 70. Razor unit 30 is any of a plurality of well known razors such as reciprocating one as shown in the invention. Razor unit 30 is provided on top (FIG. 1) or bottom (FIG. 3) of housing 10. As shown in FIG. 6, razor unit 30 comprises a motor 31 in housing 10 and below cavity 11 and a vibration mechanism 32 eccentrically mounted on a spindle 311 of motor 31 having an elastic lug 321 on either side with one end secured to the inner wall of housing 10 such that as motor 31 rotates vibration mechanism 32 may vibrate laterally because vibration mechanism 32 and spindle 311 are eccentrically coupled and the biasing of elastic lug 321. Vibration mechanism 32 further comprises a shaft 322 projected upward into cavity 11 and a dust cover 323 for sealing an opening 111 below cavity 11 for preventing dust or other foreign particles from entering. Razor unit 30 further comprises a razor 33, a mesh member 34, and a cap 35. Referring to FIG. 6 specifically, razor 33 is mounted on shaft 322 of vibration mechanism 32 capable of vibrating laterally also (FIG. 7). Razor 33 has a plurality of longitudinal equally spaced arcuate blades 331 (FIG. 5) or a plurality of mesh-like arcuate blades 331 (FIG. 4 as the one implemented by the invention).

Referring to FIGS. 1 to 5 specifically, mesh member 34 is shaped to cover razor 33 by leaving a gap therebetween. Mesh member 34 has a plurality of openings 341 disposed corresponding to the distance between two adjacent blades 331. Cap 35 is clung onto the edges of mesh member 34. Cap 35 has a plurality of tabs 351 on either side each clung to a slot 112 on the top edge of cavity 11 for securing mesh member 34 to cavity 11. Hence, blades 331 of razor 33 may shave hair from a body.

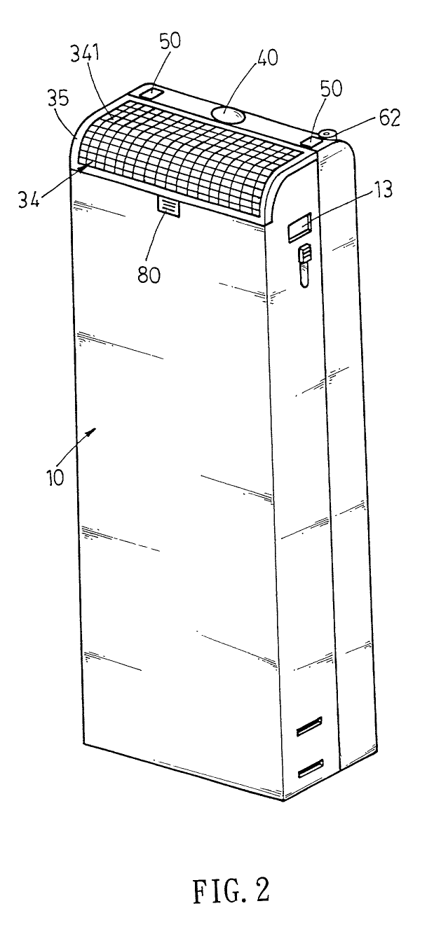

Referring to FIGS. 4 to 6 specifically, a recess 113 is provided on either side of cavity 11. An elastic positioning member 14 is clung in recess 113. Positioning member 14 has an externally extending member 141 snapped to the underside of a flange 332 on either side of razor 33 for biasing against razor 33 in an disabled state and maintaining razor 33 in a balanced state. Hence, blades 331 may align with opening 341 of mesh member 34 for preventing dust or other foreign particles from entering (FIG. 8). This is an advanced design. Moreover, a dust channel 12 is extended from bottom of cavity 11 to the outside for passing scrap to the outside. A pivot gate 13 is provided on the opening of dust channel 12. In an opening state of pivot gate 13, scrap can pass to the outside of housing 10 through pivot gate 13. To the contrary in a closed state thereof, scrap are prevented from passing to the outside (FIG. 6). It is required to clean razor unit 30 after a predetermined period of time of usage. However, it is not easy to remove cap 35 by pushing it upward since it is secured to cavity 11. Hence, a latch 80 is provided on the central edge of cavity 11 for facilitating the removal of cap 35 as well as subsequent cleaning of razor unit 30 (FIG. 2).

Illuminator 40 is provided on a position on housing 10 such as on the top of housing 10 (FIG. 1) or on the rear side of housing 10 (FIG. 3). Illuminator 40 is powered by circuit board 70 for illumination as in a power out condition or poor light environment. Contact 50 is provided on either side of illuminator 40 on the top of housing 10 or on the bottom of housing 10. Circuit board 70 can supply power to other devices. It is understood that after a period time of use battery of mobile phone will be discharged. Thus there is no sufficient power supplied to circuit board 70 from battery. As a result, contact 50 is disabled since no sufficient power supplied from circuit board 70. Further, a gas gun 60 is provided in housing 10 in the invention. Gas gun 60 consists of a gas reservoir 61, an outlet 62 slightly projected from the surface of housing 10, and an inlet 611 in communication with gas reservoir 61 for filling gas therein (FIGS. 6 and 7). A pipe interconnects gas reservoir 61 and outlet 62. Hence, user can operates operating module 20 to spray gas from outlet 62. By the provision of gas gun 60, the mobile phone accordingly can serve as a self-defense means in an emergency such as attack by an evil person.

Circuit board 70 is provided in housing 10. Circuit board 70 comprises various components for effecting a wireless communication including signals transmitting and receiving. Such components are comprised of a receiver 71, a display panel 72, a transmitter 73, etc. On the display panel 72, in addition to communication elements, there are provided a pair of rechargeable batteries 76 and 77, a transformer 74 for transferring electrical energy of rechargeable battery 76 into a higher voltage one for motor 31 and illuminator 40, and a booster 75 for greatly increasing the output current of rechargeable battery 76 for contact 50. Note that rechargeable battery 77 is a backup source. That is, rechargeable battery 77 can serve as main source if the rechargeable battery 76 is too low. A charging plug 90 is provided in a socket of housing 10. User may directly insert charging plug 90 into an outlet for charging the rechargeable batteries 76 and 77 once they are low. This eliminates the need of carrying a portable adapter or other batteries. Note that circuit board 70 does not contain elements for wireless communication as the subject of invention. Hence, its detail description is omitted herein for the sake of brevity.

In brief, by utilizing above configuration of the invention, user can manipulate operating module 20 to control circuit board 70 for transmitting or receiving signals as well as operate razor unit 30, illuminator 40, contact 50, and gas gun 60. Moreover, when the invention serves as a self defense means in an emergency by manipulating operating module 20, contact 50 can discharge a high voltage in a sudden and increase volume of speaker 73 of circuit board 70. Hence, the invention can realize a self-defense means and a warning in such condition. In other words, the invention incorporate the features of mobile phone, shaver, lighting, high voltage output, and self defense. This practical, convenient, and multifunctional electrical device can satisfy people.

While the invention has been described by means of specific embodiments, numerous modifications and variations could be made thereto by those skilled in the art without departing from the scope and spirit of the invention set forth in the claims.

What is claimed is:

1. A mobile phone comprising:
a housing;
a razor unit on said housing having an internal motor for shaving hair from a body;
an illuminator on said housing for illumination;
a pair of contacts on said housing for discharging a high voltage in a sudden served as a first self defense means in an emergency;
a circuit board in said housing for effecting a signal transmitting and a signal receiving comprising a plurality of pairs of rechargeable batteries, a transformer for transferring electrical energy of one of said rechargeable batteries into a higher voltage one for said motor and said illuminator, and a booster for increasing an output current of one said rechargeable batteries for said contacts; and
an operating module on a front side of said housing having a plurality of keys coupled to said circuit board so that said operating module is operative to command said circuit board for transmitting or receiving signals and operate said razor unit, said illuminator, and said contacts.

2. The mobile phone of claim 1, wherein said housing has a cavity with a lower opening, said motor has a spindle, and said razor unit further comprises a vibration mechanism eccentrically mounted on said spindle including an elastic lug on either side with one end secured to an inner wall of said housing such that as said motor rotates said vibration mechanism vibrates laterally, a shaft projected upward into said cavity and a dust cover for sealing said opening of said cavity; a razor mounted on said shaft capable of vibrating laterally as said vibration mechanism vibrates; a mesh member shaped to cover said razor by leaving a gap therebetween for permitting said razor to shave; and a cap clung onto edges of said mesh member.

3. The mobile phone of claim 2, wherein said razor has either a plurality of longitudinal equally spaced arcuate blades or a plurality of mesh-like arcuate blades.

4. The mobile phone of claim 2, wherein said mesh member has a plurality of openings disposed corresponding to a distance between two of said adjacent blades.

5. The mobile phone of claim 2, wherein said razor further comprises a flange on either side and said housing further comprises a recess on either side of said cavity and an elastic positioning member clung in said recess having an externally extending member snapped to an underside of said flange for biasing against said razor in an disabled state and maintaining said razor in a balanced state so that said blades are aligned with said opening of said mesh member for preventing dust or other foreign particles from entering.

6. The mobile phone of claim 1, wherein said razor unit is provided on a top of said housing.

7. The mobile phone of claim 1, wherein said razor unit is provided on a bottom of said housing.

8. The mobile phone of claim 1, further comprising a gas gun in said housing including a gas reservoir and an outlet projected from a surface of said housing for spraying gas served as a second self defense means in an emergency.
